(19) United States
(12) Patent Application Publication
(10) Pub. No.: US 2004/0027440 A1
(43) Pub. Date: Feb. 12, 2004

(54) Inkjet recording medium

(75) Inventors: Julie Baker, Leavesden (GB); Joanne Hunt, Abbots Langley (GB)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 10/631,236

(22) Filed: Jul. 31, 2003

(30) Foreign Application Priority Data
Aug. 9, 2002 (GB) 0218505.6

(51) Int. Cl. B41J 2/01

(52) U.S. Cl. 347/105

(57) ABSTRACT

The invention provides an inkjet recording medium, comprising a support and an ink receiving layer supported on the support. The ink receiving layer comprising a porous hydrophilic polymer.

### FIELD OF THE INVENTION

The present invention relates to an inkjet recording medium (receiver).

### BACKGROUND OF THE INVENTION

Inkjet printing is a process in which a stream of ink, preferably in the form of droplets, is ejected at high speed from nozzles against a medium so as to create an image.

Media used for inkjet recording need to be dimensionally stable, absorptive of ink, capable of providing a fixed image and compatible with the imaging materials and hardware.

Most commercial photo-quality inkjet media can be classified in one of two categories according to whether the principal component material forms a layer that is porous or non-porous in nature. Inkjet media having a porous layer are typically formed of inorganic materials with a polymeric binder. When ink is applied to the medium it is absorbed into the porous layer by capillary action. The ink is absorbed very quickly, but the open nature of the porous layer can contribute to instability of printed images, particularly when the images are exposed to environmental gases such as ozone.

Inkjet media having a non-porous layer are typically formed of one or more polymeric layers that swell and absorb applied ink. However, due to limitations of the swelling mechanism, this type of media is slow to absorb the ink, but once dry, printed images are often stable when subjected to light and ozone.

Japanese Patent application number 2001162924 in the name of Dainippon Ink and Chemicals, discloses an ink receiving layer comprising a porous receiver in which the pores are filled with a hydrophilic polymer. The pores are formed by irradiation of the receiver.

United States Patent application number US2001/0021726 in the name of James F Brown relates to the use of a porous resinous material for retaining biological samples. An inkjet recording medium is required that addresses the problems identified above.

### SUMMARY OF THE INVENTION

According to the present invention, there is provided an inkjet recording medium, comprising a support and an ink receiving layer supported on the support. The ink-receiving layer comprises a porous hydrophilic polymer. Any suitable swellable polymer may be used as the hydrophilic polymer in the ink-receiving layer.

Preferably, the porous hydrophilic polymer includes polyvinyl alcohol.

Any suitable material may be used as the support. Possible examples include resin-coated paper and film base i.e. polyethylene terephthalate (PET).

### ADVANTAGEOUS EFFECT OF THE INVENTION

The present invention provides an inkjet media having a porous hydrophilic polymer layer. This enables faster absorption of the ink to be achieved compared to a pure non-porous hydrophilic polymer layer, whilst still maintaining the image stability that is achieved from a non-porous medium. When compared to a conventional porous medium, the medium of the present invention shows significant improvements in image stability.

As will be explained below, one possible method suitable for the manufacture of media according to the present invention, involves the use of blowing agents. By using blowing agents in conjunction with a hydrophilic polymer e.g. a swellable hydrophilic polymer, a swellable porous medium is produced. This results in improved absorption of the ink and dye within the ink. However, instead of the dye being held in pores which are located in between particles (which is the case for traditional porous media) the dye is located within the polymer, thereby improving image stability.

### BRIEF DESCRIPTION OF THE DRAWINGS

Examples of the present invention will now be described in detail with reference to the accompanying drawings, in which:

FIG. 1 is a schematic representation of a section through an inkjet medium according to the present invention;

FIG. 2 is a schematic representation of a section through a conventional non-porous inkjet medium;

FIG. 3 is a scanning electron micrograph through an inkjet medium according to the present invention; and,

FIG. 4 is a scanning electron micrograph through a conventional nonporous inkjet medium;

### DETAILED DESCRIPTION OF THE INVENTION

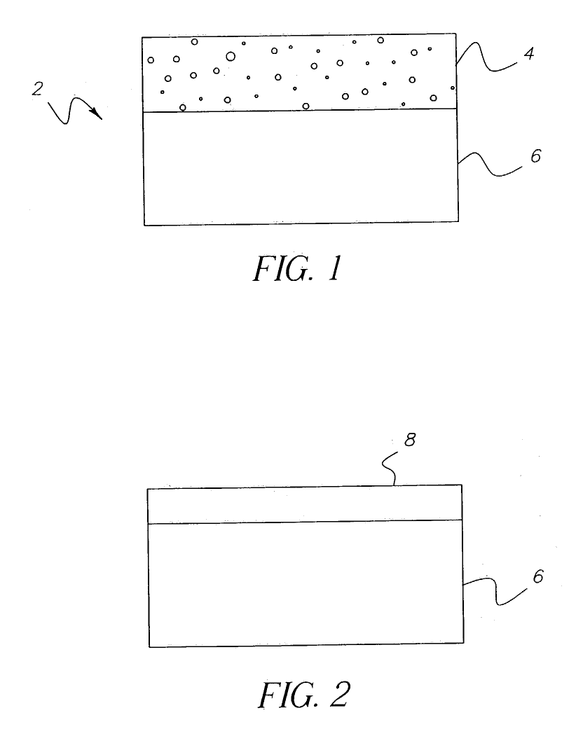

FIG. 1 is a schematic representation of a section through an inkjet medium according to the present invention. The medium 2 comprises a support layer 6, such as resin-coated paper, PET film base, acetate, printing plate or any other suitable support and a polymeric layer 4 of porous hydrophilic polymer supported thereon.

In most cases the hydrophilic polymer will be swellable. However, it is possible that an amount of crosslinker such as borax, tetraethyl orthosilicate, 2,3-dihydroxy-1,4-dioxane (DHD) or any other suitable crosslinker may be added to the polymer to provide an amount of crosslinking to the polymeric layer 4. Any suitable hydrophilic polymer may be used in the porous hydrophilic polymer layer including, amongst others, polyvinyl alcohol (PVA), polyethylene oxide (PEO), polyvinyl pyrrolidone (PVP) and gelatin.

FIG. 2 shows a schematic representation of a section through a conventional non-porous inkjet medium. In this case a non-porous polymeric layer 8 is supported on the support layer 6.

A surfactant such as Olin 10G may also be added to the hydrophilic polymer used in the porous hydrophilic polymeric layer 6 and serves as a coating aid. Examples of other suitable surfactants include Lodyne S100, Zonyl FSN or any other flouro-surfactant.

One possible method for making the material relies on the coating of a support with a solution comprising a hydrophilic polymer and a blowing agent, and optionally a surfactant. Such a method is described in detail in our copending UK Patent Application entitled “A Method of Making a Material” having the same filing date as the present application and having our internal docket number 84594.

In one example, three layers of solution of a polymer are coated simultaneously onto a support. It is possible that the proportion by weight of blowing agent to polymer in the different layers varies. In any one or more of the layers the proportion by weight of blowing agent to polymer may be up to about 200%, although typically it would be in an amount from about 10% to about 60%, preferably about 30% to about 50%. The proportion by weight of surfactant, where present, to solution in the different layers may also vary. Typically, it would be in an amount from about 0.01% to about 2.0%, preferably, about 0.01% to about 1.0%. In the case where any number of layer(s) of solution of polymer are coated, the proportions by weight of blowing agent to polymer and surfactant, where present, to solution may have values in the same ranges.

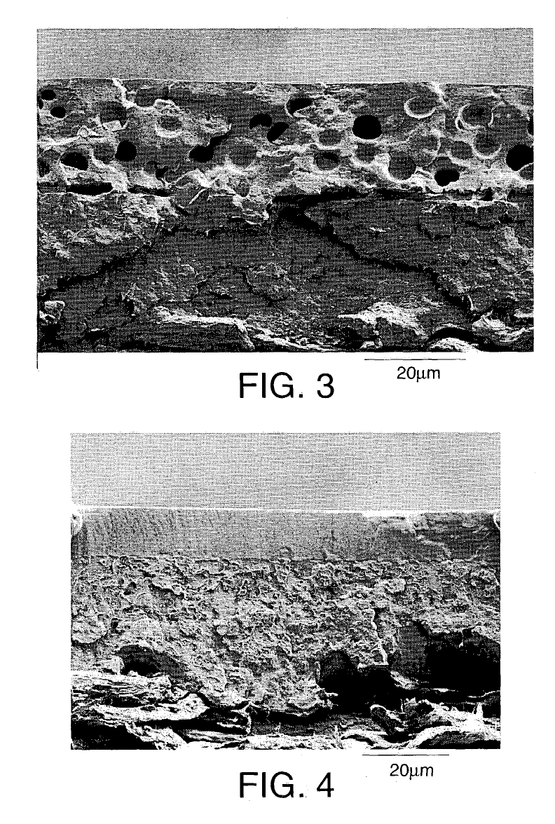

FIGS. 3 and 4 show scanning electron micrographs of a section through an inkjet receiver according to the present invention and a conventional nonporous polymer inkjet receiver, respectively. As shown schematically in FIGS. 1 and 2 bubbles are clearly visible in the polymer layer in FIG. 3.

The invention is illustrated by the following example.

### EXAMPLE

An inkjet medium was prepared as follows:

Three layers of polymer were coated simultaneously by a bead-coating machine using a conventional slide hopper onto a support consisting of a resin-coated paper. Each polymer layer functions as an ink-receiving layer when the medium is used for inkjet printing. In this example, each ink-receiving layer comprises polyvinyl alcohol (PVA), blowing agents (a total of 50% by weight compared to the mass of PVA per unit area) and an amount of surfactant.

The ink-receiving layer nearest the resin-coated paper support consisted of 6.1 g/m² of PVA, 1.72 g/m² of sodium nitrite, 1.33 g/m² of ammonium chloride and 0.212 g/m² of Olin 10G surfactant. The middle ink-receiving layer consisted of 6.8 g/m2 of PVA, 1.92 g/m² of sodium nitrite, 1.48 g/m2 of ammonium chloride and 0.424 g/m² of Olin 10G surfactant. The top ink-receiving layer consisted of 7.5 g/m² of PVA, 2.11 g/m² of sodium nitrite, 1.64 g/m² of ammonium chloride and 0.636 g/m² of Olin 10G surfactant.

For comparison, a control coating was also prepared at the same time where the layers were identical to those described above, except the blowing agents (sodium nitrite and ammonium chloride) were omitted.

To initiate the blowing process, the dryers inside the coating track were set to 90° C. through which the coated supports (used in the preparation of the medium according to the present invention and the control) were passed. As shown schematically in FIG. 1, the blowing agents have reacted due to the heat in the dryers causing voids to form and resulting in a foamed polymeric layer. This can be compared to the control coating, shown schematically in FIG. 2, where no voids can be seen.

Drytime and image stability were then compared for these two coatings. As an additional comparison, data for a commercially available porous medium (Epson Photo Glossy Paper) is also shown.

Drytime was evaluated by measuring the density of ink transferred to a piece of plain paper sandwiched to a printed image immediately after printing. The faster the sample dries the lower the ink density on the plain paper.

The following Printer set-up was used:

Printer:

Epson Stylus Photo 870

Printer Settings:

Print quality—photo 1440 dpi

Premium Glossy Photo Paper

The results in table 1 show the density of ink transferred during the drytime test.

TABLE 1
Density of ink transferred during drytime test.

| Coating | Density of Ink Transferred |
|---|---|
| Foamed Polymer Medium | 0.55 |
| PVA Control Coating | 0.78 |
| Epson Glossy Photo Paper | 0.02 |

The data in table 1 show that the foamed polymer medium transfers less ink during the drytime test than the PVA control coating does, which indicates that the coating of this invention absorbs the ink quicker. As expected, the commercially available porous medium, Epson Glossy Photo Paper transfers almost no ink at all due to its porous nature.

The light stability of the various media were assessed by printing an image, measuring the densities of the various colours (choosing a patch that has the density closest to 1.0) and then subjecting it to high intensity daylight (HID, 50 KLux) for a period of 7 days. The same colour patches were then measured again at the end of the 7 day period and the loss of density calculated.

The light stability results are shown in table 2.

TABLE 2
Light stability data

| Ctg | | Cyan | Magenta | Black | Green | Blue |
|---|---|---|---|---|---|---|
| Foamed | Fresh | 0.846 | 1.296 | 1.020 | 1.066 | 1.152 |
| Polymer | Faded | 0.822 | 1.027 | 1.005 | 1.061 | 1.103 |
| Medium | Delta | −2.8% | −20.8% | −1.5% | −0.5% | −4.3% |
| PVA | Fresh | 1.102 | 0.920 | 1.289 | 1.049 | 0.940 |
| Control | Faded | 1.089 | 0.772 | 1.257 | 1.048 | 0.906 |
| | Delta | −1.2% | −16.1% | −2.5% | −0.1% | −3.6% |
| Epson | Fresh | 0.836 | 1.377 | 1.115 | 0.900 | 1.405 |
| Glossy | Faded | 0.766 | 0.962 | 0.978 | 0.816 | 1.225 |
| Photo | Delta | −8.4% | −30.1% | −12.3% | −9.3% | −12.8% |

The following Printer set-up was used:

Printer:

Epson Stylus Photo 870

Printer Settings:

Print quality—photo 1440 dpi

Premium Glossy Photo Paper

The data in table 2 show that for the colours measured, the light stability of an image printed onto the foamed polymer medium is as good as that achieved from the PVA control and also shows a significant improvement over the light stability exhibited by a commercially available porous medium (Epson Glossy Photo Paper).

The ozone stability of the respective media were then assessed by printing an image, measuring the densities of the various colours (choosing a patch that has the density closest to 1.0) and then subjecting it to ozone (1 ppm) for a period of 24 hours. The same colour patches were then measured again at the end of the 24 hour period and the loss of density calculated.

The ozone stability data are shown in table 3.

TABLE 3
Ozone stability data

| Ctg | | Cyan | Magenta | Black |
|---|---|---|---|---|
| Foamed | Fresh | 1.021 | 0.916 | 0.921 |
| Polymer | After 24 Hrs | 1.085 | 0.909 | 0.958 |
| Medium | Delta | +6.3% | −0.8% | +4.0% |
| PVA | Fresh | 0.986 | 1.018 | 1.057 |
| Control | After 24 Hrs | 0.953 | 1.022 | 1.053 |
| | Delta | −3.4% | +0.4% | −0.4% |
| Epson | Fresh | 0.931 | 1.082 | 0.811 |
| Glossy | After 24 Hrs | 0.653 | 0.411 | 0.496 |
| Photo | Delta | −29.9% | −62.0% | −38.8% |

In this case, the following printer set up was used:

Printer:

Kodak PPM 200

Printer Settings:

Print quality—high resolution (1200×1200 dpi)

Kodak Premium Paper

The data in table 3 show that for the colours measured, the ozone stability of an image printed onto the foamed polymer medium is as good as that achieved from the PVA control. The data also show a significant improvement over the ozone stability for the medium of the present invention over that exhibited by a commercially available porous medium (Epson Glossy Photo Paper).

From this example, it can be seen that by using a foamed (and therefore voided) polymer layer as an inkjet medium, improved drytime can be achieved compared to a non-porous PVA layer. It can also be seen that the image stability from this type of medium is comparable to that of a non-porous medium and shows significant improvement in image stability over a traditional porous medium, such as the Epson Glossy Photo Paper.

1. An inkjet recording medium, comprising:
a support; and,
an ink receiving layer supported on said support, said ink receiving layer comprising a porous hydrophilic polymer.

2. A medium according to claim 1, in which the porous hydrophilic polymer is swellable.

3. A medium according to claim 1, in which said ink receiving layer includes a crosslinker.

4. A medium according to claim 1, in which said ink receiving layer includes a surfactant.

5. A medium according to claim 1, in which the porous hydrophilic polymer includes at least one polymer selected from the group consisting of polyvinyl alcohol, polyethylene oxide, polyvinyl pyrrolidone and gelatin.

6. A medium according to claim 1, in which the support is made of a material selected from the group consisting of resin-coated paper, PET, acetate and printing plate.

7. A medium according to claim 4, in which the surfactant is a flouro-surfactant.

8. A medium according to claim 7, in which the surfactant is selected from the group consisting of OLIN 10G, Lodyne S100 and Zonyl FSN.

9. A medium according to claim 4, in which the proportion by weight of surfactant to coating solution used in the preparation of the medium is in an amount from about 0.01% to about 2.0%, preferably, about 0.01% to about 1.0%.

10. A medium according to claim 1, the porous hydrophilic polymer being formed by the decomposition of a blowing agent in a solution of said hydrophilic polymer.

11. A medium according to claim 10, in which the proportion by weight of blowing agent used in the preparation of said medium to hydrophilic polymer is up to about 200%.

12. A medium according to claim 11, in which the proportion by weight of blowing agent used in the preparation of said medium to hydrophilic polymer isin an amount from about 10% to about 60%, preferably about 30% to about 50%.
